(19) United States
(12) Patent Application Publication
(10) Pub. No.: US 2010/0268879 A1
(43) Pub. Date: Oct. 21, 2010

(54) SECURE DIGITAL MUSIC ALBUM FORMAT

(76) Inventor: Jaromir (Jarek) Krzysztof WASZCZYSZYN, KRAKOW (PL)

Correspondence Address: Sawyer Law Group, P.C., P.O. Box 51418, Palo Alto, CA, 94303, US

(21) Appl. No.: 12/565,714

(22) Filed: Sep. 23, 2009

Related U.S. Application Data
(60) Provisional application No. 61/169,687, filed on Apr. 15, 2009.

(51) Int. Cl. G06F 12/00

(52) U.S. Cl. 711/115; 711/E12.001

(57) ABSTRACT

A Removable Memory Device and method of use is disclosed. Instead of exchanging the data associated with multimedia information from one media carrier to another, the media carrier itself is transferred from one player to another. The media is integrated, easy to use, and is possible to apply both to the low quality as well as the high quality audio environment. A new format for the memory card is provided. The new format includes but is not limited to music, as well as a booklet, cover, text information, video and photo gallery. The new format does not limit the Removable Memory Device/SD card to only a media carrier but constitutes, rather, a dedicated and controlled interface to Internet contents. At the same time, there are be a range of players that are created for personal, portable, car audio, as well as hi-fi and hi-end.

### CROSS-REFERENCE TO RELATED APPLICATIONS

This application claims the benefit of U.S. Provisional Application No. 61/169,687, filed Apr. 15, 2009, Attorney Docket No. 4531 PR, entitled, “SECURE DIGITAL MUSIC ALBUM FORMAT”; all of which are incorporated herein by reference in their entireties.

This application is related to U.S. Provisional Application No. 61/141,624, filed Dec. 30, 2008, Attorney Docket No. 4825PR, entitled, “AUDIO FLASH MEMORY CARD”; and co-pending U.S. patent application Ser. No. ______ (To Be Assigned), Attorney Docket No. 4825P entitled “A REMOVABLE MULTIMEDIA MEMORY CARD AND METHOD OF USE,” filed on even date herein, which is incorporated by reference in its entirety.

### FIELD OF THE INVENTION

The present invention relates generally to a multimedia album and more particularly to a format for providing such an album on a Removable Memory Device.

### BACKGROUND

Solid-state memories have been used for years in portable MP3 players. In some players, for example, modern multi-function cellular phones, it is possible to prepare Removable Memory Devices with different music on each device. Then, by taking out one card and inserting another, the music can be changed accordingly. But these solutions all use low-quality devices, such as compressed audio data in MP3 format, and other similar processes. This is because, until recently, the capacity of memories was limited.

Compact Disc's were a revolution in audio, not due to high sound quality (sound quality of the first CD players was poor) but rather due to their ease of operation, and their portable use compared to vinyl long playing records (LPs) or a compact cassette.

The CD standard is very well designed (it has worked since 1982). It has limitations due to size, capacity and the needs of precision mechanics/optics. Also, another limitation is that it is very easy to make pirate copies from a CD.

Super Audio Compact Disc (SACD) DVD Audio (DVD-A) and Blue Ray disks were introduced that provided for higher sound quality than conventional CDs. However, these types of disks have not been highly successful commercially.

### Format Issues

There are different formats which provide audio. Some of those formats provide a low quality sound and others provide a high quality sound. Some of the issues with utilizing these formats in providing audio will be described below.

### Formats for Lower Quality Sound

Examples of formats utilized for relatively low quality sound are MetaFrame Presentation Server 3 (MP3), and Advanced Audio Coding (AAC). MP3, AAC and other formats are utilized for lower sound quality while using lossy compression. Devices that utilize these formats typically need less than 10% of memory (as compared with original data). Devices that utilize these formats include portable devices such as the iPod®, car audio, home audio and software (songs, tunes).

A growing group of these players can read data from Flash memory cards. However, for the most part, the data is read as compressed, low quality MP3 format.

So there exists a large range of products ready for music stored in Flash memory cards, but these products are typically utilized only for low quality MP3 players.

### Formats for High Quality Sound

Typically, high quality formats are utilized when downloading to and from music servers. These exist as hardware (stationary music servers) and software (files with music to download). An example of a high sound quality format is Free Lossless Audio Codec (FLAC) (http://flac.sourceforge.net/). The FLAC format is compressed, but lossless, meaning that audio is compressed in FLAC without any loss in quality. FLAC files need 50% of the memory (as compared with original data), and the files can also include cover pictures, and some basic information about musicians. The format is license free.

However, a high quality format such as the FLAC format has several problems. For example, there is a problem with piracy due to the ease of copying of the music files. In addition, there is a complete disorder/disintegration in downloading data with different formats. There are many non-compatible formats, and thus the format needs a constant upgrading for software plug-ins.

### Formats are Separate for Low and High Quality Music

One of the biggest problems with existing solutions is that these two worlds of low (inexpensive) and high (expensive) quality music are separate. There does not exist, at present, any commercial solution or any way of exchanging files. One solution is to “upgrade” the portable player by manufacturing better quality devices, or by very expensive outboard converters.

This type of solution is not very effective, because the portable players use only compressed data, like MP3, AAC and other formats. Therefore over 90% of the music data is lost using these formats. Portable players also have a small display and very small buttons. Many people find these difficult and uncomfortable to see and use respectively.

Moving in the opposite direction, downloading music from a server to a portable player has not been considered seriously, because the servers are expensive. True music lovers, a potential group of customers who can be served by the music server, will require higher standards of listening for sound than will their children and many adults, who will continue to be the users of inexpensive devices.

Today, there is not a universal music data file in a format which may be applied both to high quality (Hi-Fi) and low quality devices. The primary way to exchange music is by exchanging data files. High quality files cannot be used in low quality devices, because there is not enough memory space. Low quality files need less memory (for portable devices) but they cannot be used in high quality audio because they do not play well.

Accordingly, what is needed is a system and method that addresses the above-identified issues. The system and method should be cost effective, easy to implement, and compatible with existing systems. The present invention addresses such a need.

### SUMMARY OF THE INVENTION

A multimedia application format and method of use is disclosed. Accordingly, instead of exchanging the data associated with multimedia information from one platform (hardware), the media carrier itself is transferred from one player to another. The media carrier is integrated, easy to use, and is possible to apply both to the low quality as well as the high quality audio environment.

The new format includes but is not limited to music, as well as a booklet, cover, text information, video and photo gallery. The new format does not limit the Removable Memory Device/SD card to only a media carrier but constitutes, rather, a dedicated and controlled interface to Internet contents. At the same time, there is a variety of players, both stationary and portable that are created for personal, portable, car audio, as well as hi-fi or state-of-the-art equipment.

### BRIEF DESCRIPTION OF THE DRAWINGS

FIG. 1 shows a Removable Memory Device including a Secure Digital Music Album (SDMusA) in accordance with the present invention that can be utilized in different environments. FIGS. 2 and 3 illustrates the features of a secure digital music album (SDMusA) format in accordance with an embodiment.

FIG. 4 illustrates is an example of data content files of a SDMusA complex album.

FIG. 5 shows a definition and a table header of the Table Of Contents (TOC) file of the SDMusA format.

FIG. 6 illustrates part 1 of a General File Table (GFT) including an album electronic booklet common files (picture, text and video).

FIG. 7 illustrates part 2 of a GFT including Track Data description (audio, text, picture, video).

FIG. 8 illustrates a definition of audio data file structure.

FIG. 9 illustrates Mega Audio Block (MAB) definition.

FIG. 10 illustrates a comparison of the TOC file structure to a TOC File for a specific album (Piece by Piece by Katie Melua)

FIG. 11 illustrates a comparison of the GFT structure to the GFT for a specific album (Piece by Piece by Katie Melua), including an electronic booklet (common text, picture and video).

FIG. 12 continues GTF comparison of the GFT structure to the GFT for a specific album (Piece by Piece Katie Melua), including track data definition

FIG. 13 illustrates a comparison of the audio file structure to the audio file for a specific album (Piece by Piece by Katie Melua, track 1)

FIG. 14 illustrates an example of an SDMusA player, able to replay all stored contents.

FIG. 15 illustrates an SDMusA player with an illuminated SD Memory Card socket, as well as a mouth-shape input for easy insertion and removal of the card.

FIG. 16 illustrates an SDMusA player with an SD card with SDMusA album(s), which can be easily removed and changed to another card.

FIG. 17 illustrates an example of an SDMusA main screen layout design.

FIG. 18 illustrates that, after placing the SDMusA album inside the card socket, the player then reads the album content organization, displays a unique album main cover, as well as total audio tracks quantity, total audio track time, operating functions and current volume settings.

FIG. 19 illustrates that by pressing any content key (right-sided) the content list is displayed.

FIG. 20 illustrates that the start playing of each track is indicated by dimmed play key, track number (left-down corner) and unique track artwork.

FIG. 21 illustrates that the SDMusA player can display a wide range of text information, such as biography, lyrics, album info, etc.

FIG. 22 illustrates an example of an SDMusA portable player.

FIG. 23 illustrates an example of an SDMusA player application for mobile phone.

FIG. 24 illustrates an example of a high quality SDMusA audio player.

FIG. 25 illustrates an internal build of a high quality SDMusA audio player

FIG. 26 illustrates an example of a high quality SDMusA audio headphone player.

### DETAILED DESCRIPTION

The present invention relates generally to a multimedia album and more particularly to a format for providing such an album on a Removable Memory Device. A Secure Digital (SD) or Secure Digital High Capacity (SDHC) or Secure Digital Extended Capacity (SDXC) in standard, mini and micro size flash memory card is the preferred Removable Memory Device. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The format in accordance with the present invention is a very attractive tool for organizing any multimedia in any digital device. It can be also utilized in any digital device or any computer program.

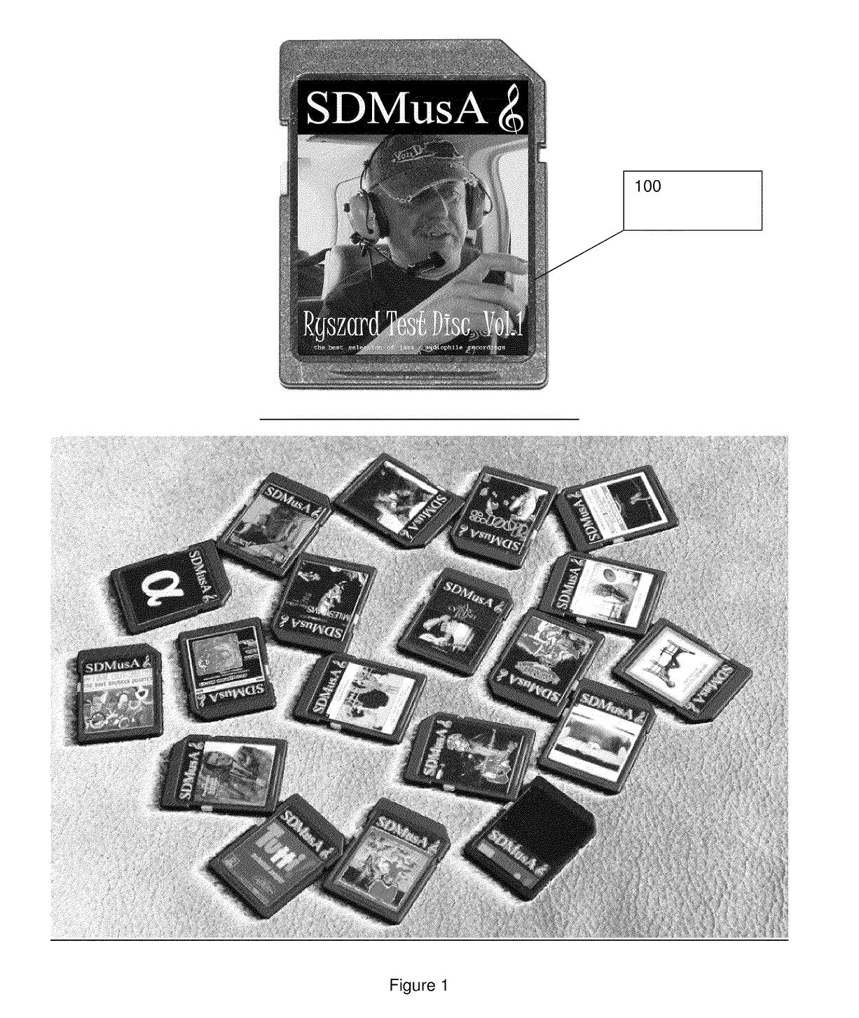

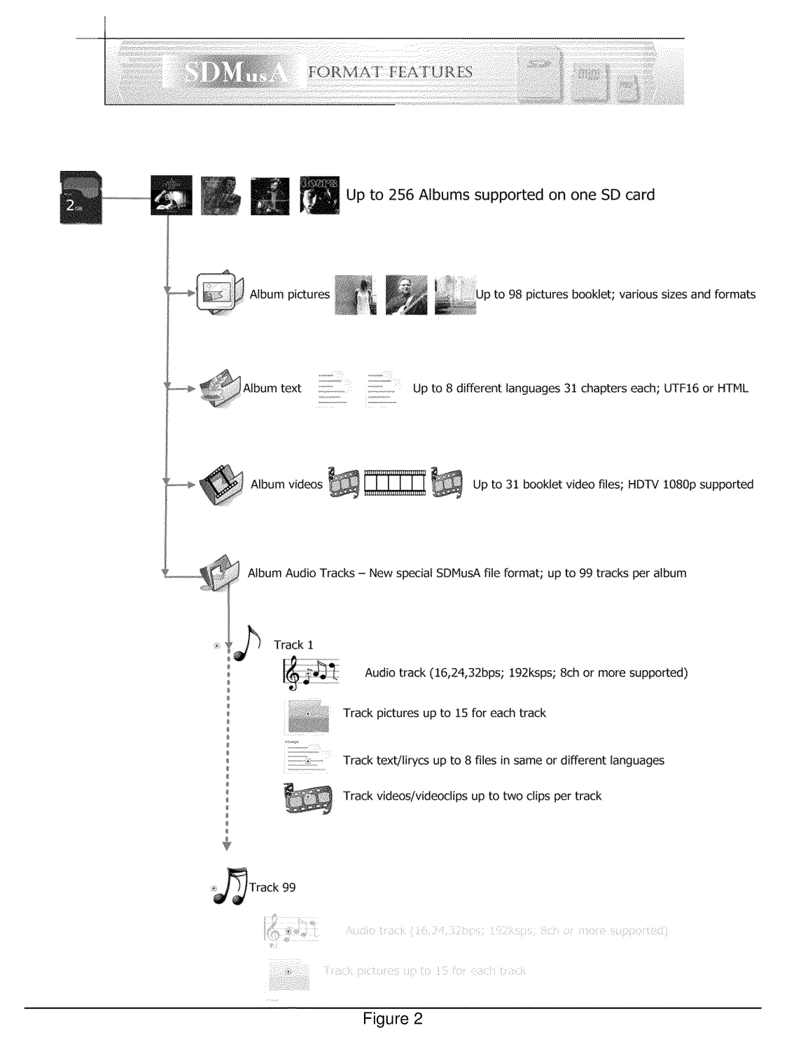

FIG. 1 shows a Removable Memory Device 100 in accordance with the present invention that can be utilized in different environments. The Removable Memory Device 100 can be used for prerecorded music, factory loaded music, or downloaded by Internet including non-compressed contents, with CD (16 bit PCM) or higher quality (24-bit, 176 kHz) audio. The recorded music and multimedia can be transferred to Hi-Fi, Hi-End home systems, portable audio, and car audio, via transferring the Removable Memory Device to the system, for example. The card 100 has a new format that includes a predetermined information set that is described and removably stored thereon.

FIG. 1 also shows different memory cards with different single or multiple Secure Digital Music Album (SDMusA). It is possible in the future to add, remove, modify of any album or of any album content (audio, text, picture, video).

### Format

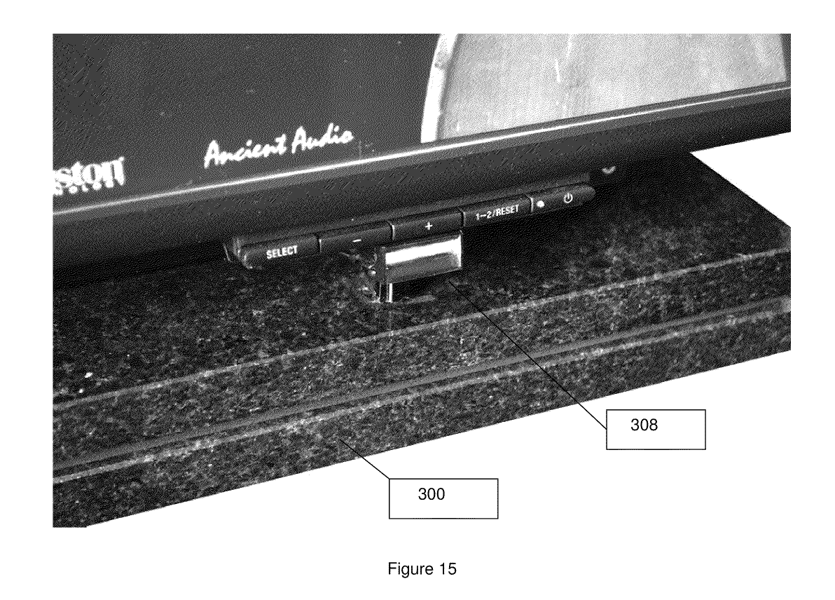

A new format is provided including a predetermined information set that is described and physically stored on the Removable Memory device that can be utilized for example in the digital players shown in FIG. 15 and FIGS. 22 to 25. For example, the new format would include a predetermined number of music tracks on every music album. In the area of picture resolution, the new format would include “a high resolution picture” with 1024x1024 pixels as optimum but not necessarily the only resolution. This 1024x1024 pixels resolution covers the biggest HD TV displays, but it is still easy to scale down into simpler, more portable devices. The new format includes but is not limited to music, as well as a booklet, music cover, text information, video and photo gallery. The new format does not limit the Removable Memory Devices to only a media carrier but constitutes, rather, a dedicated and controlled interface to Internet contents. Also the new format is not limited to a particular media, it can operate on any digital platform.

To describe the features of the format in more detail refer now to the following description in conjunction with the accompanying Figures.

### Format Description

FIGS. 2 and 3 illustrate the features of a secure digital music album (SDMusA) format in accordance with an embodiment. As is seen the features of the format include predetermined information set therewithin. In this embodiment, there can be up to 256 albums. Each album includes album pictures, album texts, album videos and album audio tracks, respectively. As is also seen each album includes up to predetermined amount of information. For example, there are up to 98 pictures per album, up to 8 different languages up to 31 chapters for each language stored in the album; up to 31 booklet video files in the album and up to 99 audio tracks in the album the tracks are stored in a file format compatible with the SDMusA format. Each track can includes further track picture, track lyrics and track video clips. In one embodiment there can be up to two video clips per track

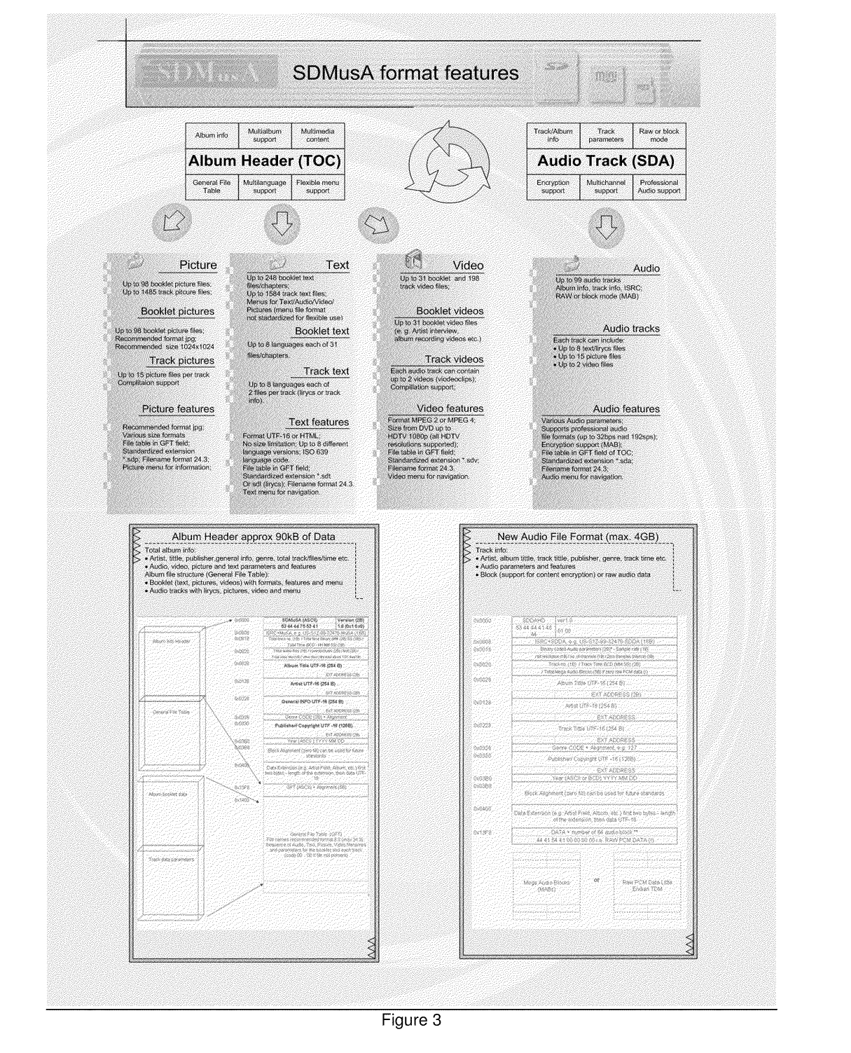

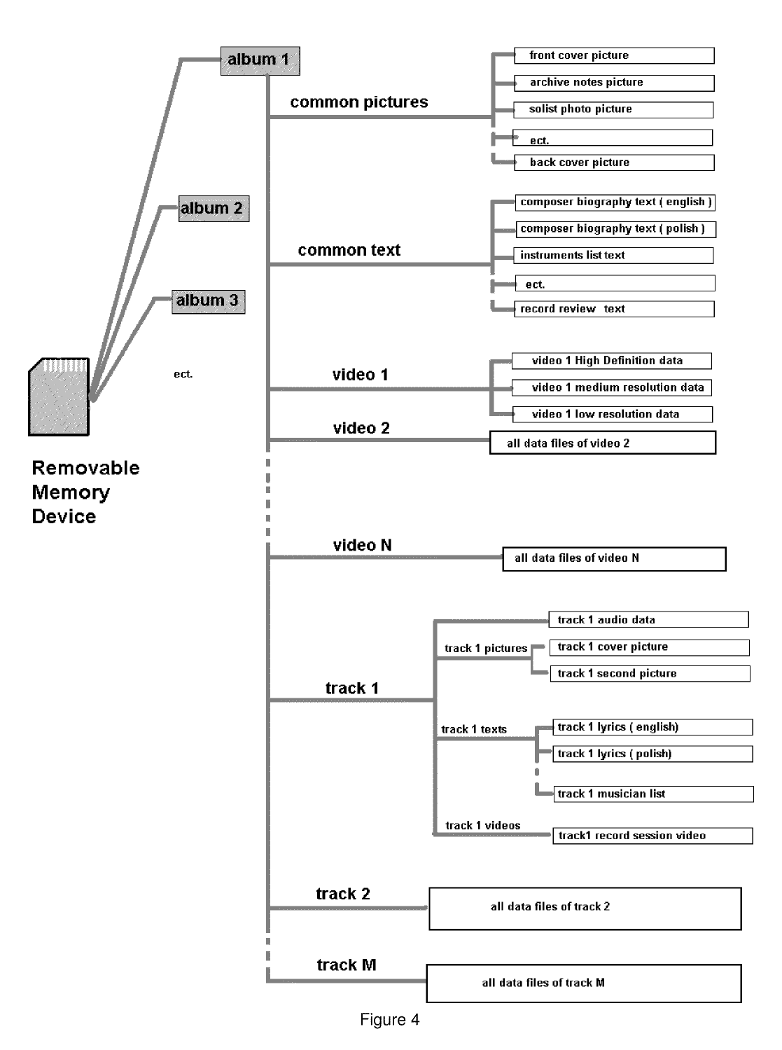

FIG. 4 shows a more detailed description of the SDMusA format abstract and main features in accordance with the embodiment. The SDMusA format stores multimedia (pictures, text, audio and video) digital data. The data files can be stored, send or transmitted on any media or digital memory way, especially on Secure Digital Flash Memory Cards and Internet. The digital data can have related or unrelated contents. The SDMusA is designed to carry high quality data, as non-compressed audio (up to 32 bit/192 kHz or more), high quality pictures, high quality video (like Full HDTV-1080p). The compressed audio data can be also stored in the SDMusA format. The SDMusA format can be used for a variety of multimedia applications. It is well suited for commercial distribution of music, video, or any other multimedia albums. All the SDMusA format files are stored on single Removable Memory Device or a single root catalogue.

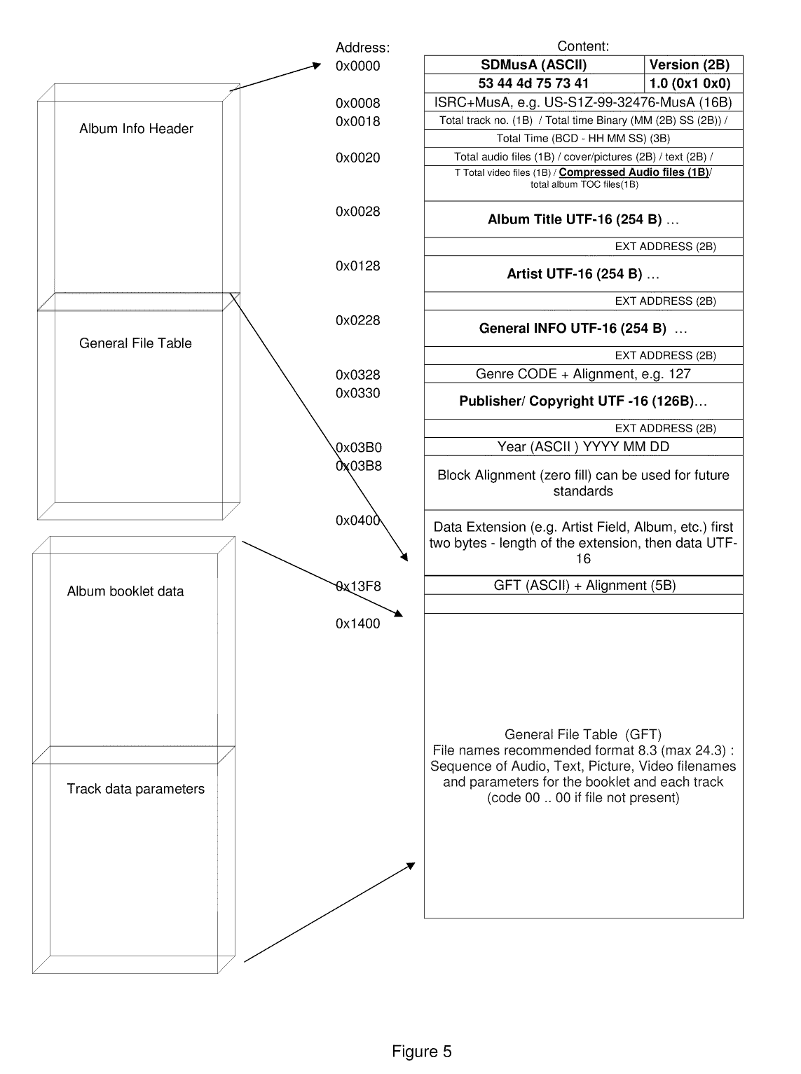

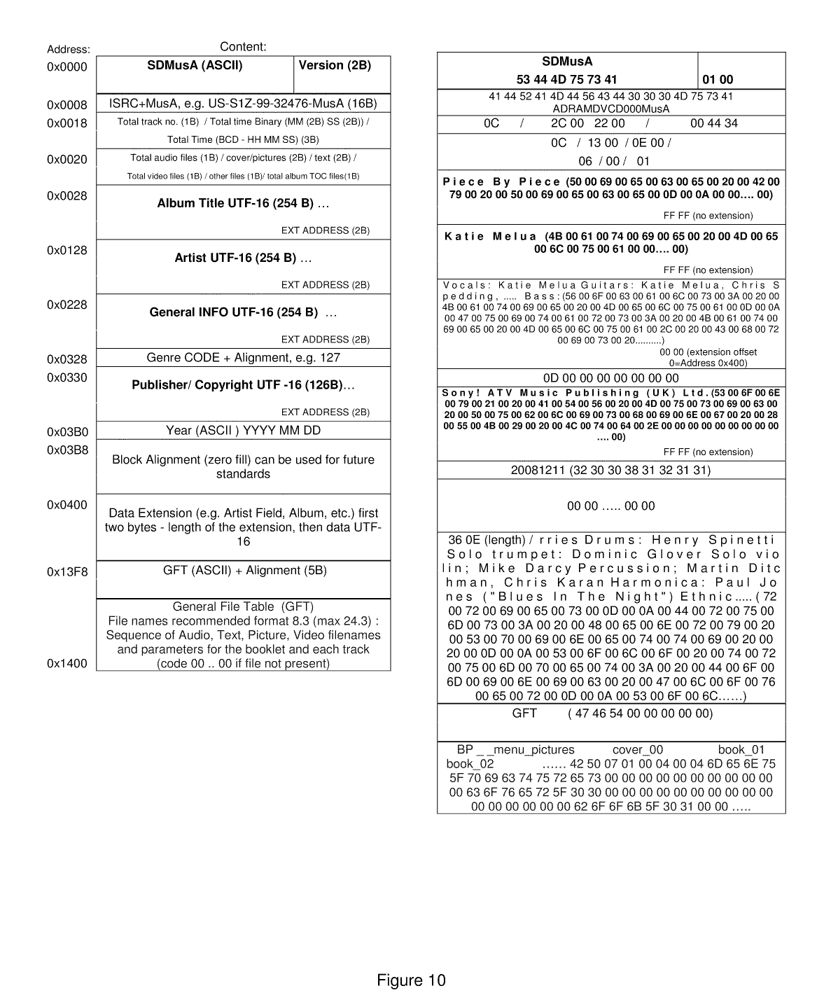

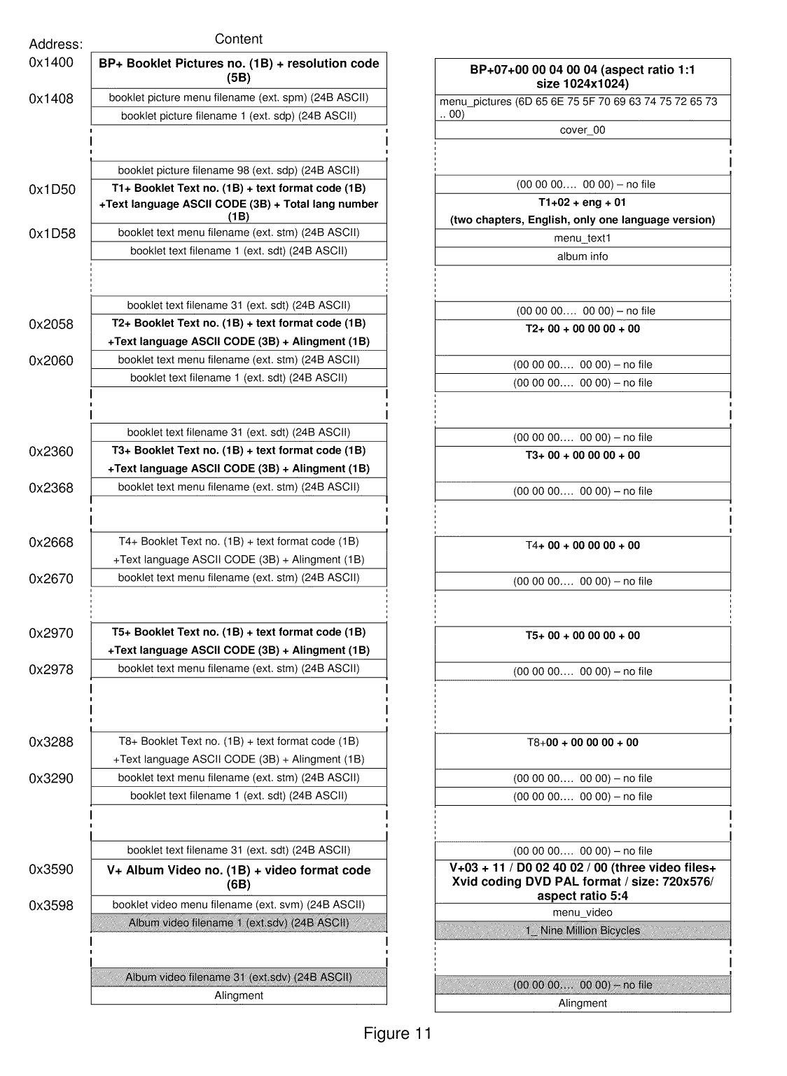

FIG. 5 illustrates an album Table of Contents and the Album Booklet data and the Track Data Parameters stored as *.toc file. The file structure of the album is defined in one Table of Contents (TOC) file, which includes an Album Info Header (AIH) field and a General File Table (GFT) field. In this embodiment, the AIH field is from address 0x0000 to address 0x0400. The AIH field occupies the first 5 kB of the TOC file and describes the basic album information (described in detail hereafter). As is also seen the GFT field is from address 0x13F8 to 0x1400. The Album Booklet Data and the Track data parameters files are from address 0x1400 onward. In this embodiment, specific addresses include specific information, for example address 0x0000 includes the version number and 0x0128 includes the album title. In so doing there is a standard way to categorize each element of the album. FIG. 10 illustrates a comparison of the TOC file structure to a TOC File for a specific album (Piece by Piece by Katie Melua)

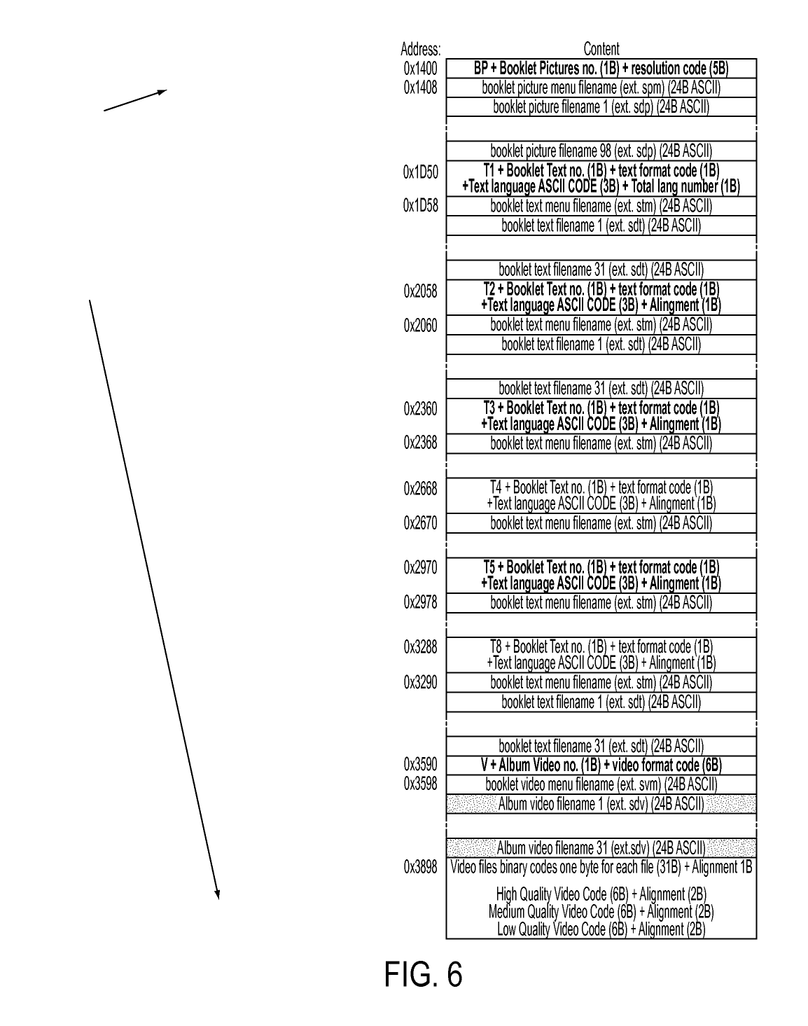

FIG. 6 illustrates the definition of the album booklet of the General File Table (GFT) file. As is seen, in this embodiment, the definition is stored from address 0x1400 to address 0x3290. Specific addresses include specific information about the album booklet. For example, the booklet picture number and resolution code are stored at address 0x1400.

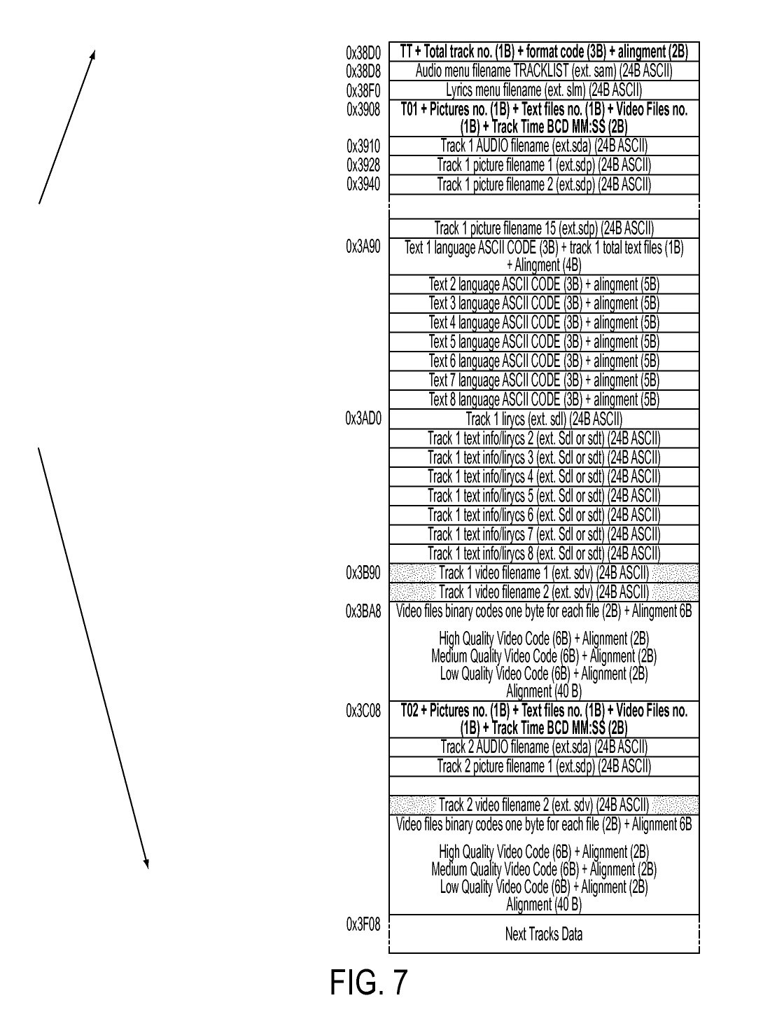

FIG. 7 illustrates the definition of the audio track format of the General File Table (GFT) file. As is seen, in this embodiment, the definition is stored from address 0x38D0 through address 0x3F08. Specific addresses include specific information about the track format. For example, the total number of tracks, format code and the alignment is stored at address 0x38D0.

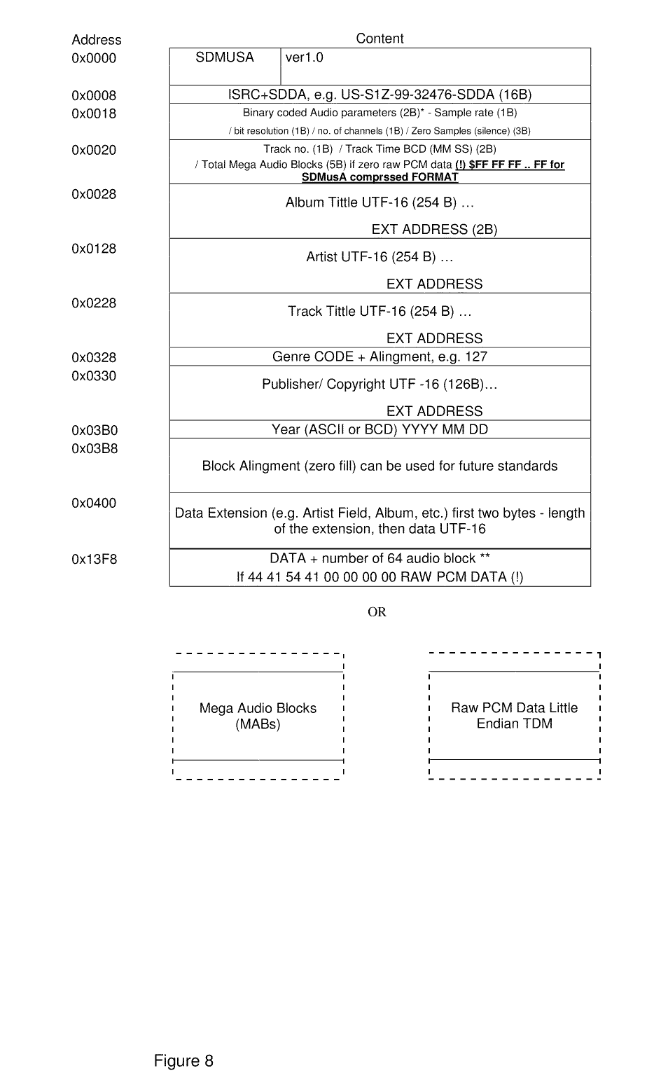

FIG. 8 illustrates the definition of the audio file format, stored as *.sda files, including the definition of audio file header. This file contains the main audio information.

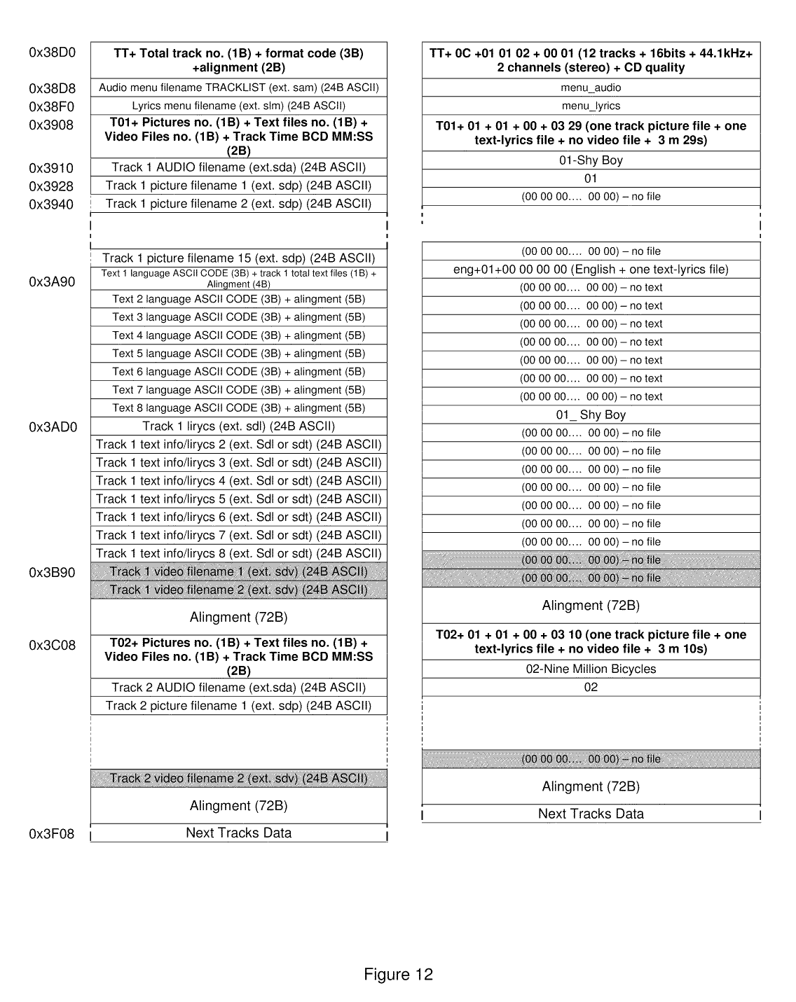

FIG. 12 defines the Mega Audio Block (MAB) that is within the AIH field. In this embodiment this information is stored within address 0x14000.

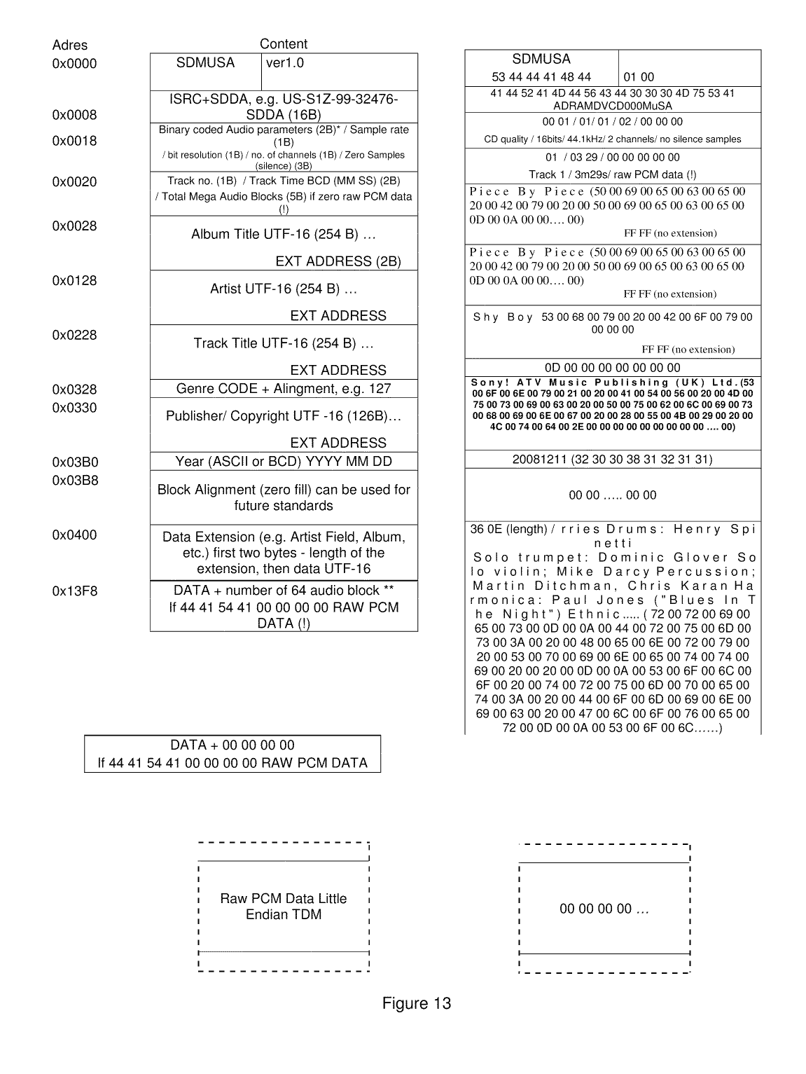

FIG. 13 illustrates a comparison of the audio file format structure to an audio file format for a specific album (Piece by Piece by Katie Melua).

### Global Information and Definition

The SDMusA format standard describes:

Standardized names of TOC files i.e.: Album001.toc Album002.toc etc. (max number of albums 256 on one SD card or other media root catalogue)

Multialbum support—the mandatory Album001.toc contain one byte field “total album TOC files” which describes how may albums are stored on the SD card or other media root catalogue

Global data alignment of 8 bytes (TOC files and Audio files)

Menus for audio, text, pictures and video (*.ini file format) should contain names/comments and/or time of the audio tracks, text chapters, video clips etc.—menu format not standardized for flexible use in different applications

Standardized extensions of album files:

*.toc (Table Of Contents)

*.sda (audio)

*.sdl (lyrics)

*.sdt (text)

*.sdv (video) of medium resolution (DVD)

*.sdw (video) of low resolution (PDA, mobile phones, etc.

*.sdh (video) of high resolution (HDTV like))

*.sdp (picture)

menu files: *.sam (audio menu); *.spm (pictures menu); *.stm (text menu); *.svm (video menu)

### Format Definitions/Limitations

### Format Identification

A unique expression or “SDMusA” expression, coded in a basic code such as ASCII must be presented at the beginning of each of the TOC files. In this example, any *.toc file of any SDMusA album must include address 0x00000 and the following Hexagonal codes: 53 44 4D 75 73 41. This is shown in detail in FIG. 5.

The “SDMusA” expression must be detected by any replaying device or computer program using SDMusA format. If it is not detected, device or computer program applying SDMusA format must be not able to reproduce any content related to *.toc file or *.toc catalogue.

Also, use of the “SDMusA” expression, described above, in the other solutions that are not in accordance with SDMusA format is prohibited.

### Pictures

Max. booklet picture files no.=99 if not present filename=00 . . . 00

ImageResolution code:

1B Aspect ratio code 4:3 (e.g. 1024x768) code 0x01, 1:1 code 0x00, 16:9 code 0x02 other reserved or to be defined

2B H size (e.g. 1024x768 code 1024)

2B V size (e.g. 1024x768 code 768)

In an example the JPEG file format (code 0x00 on first byte+Aspect ratio code) is used. Other formats could be coded on the first byte together with the aspect ratio code.

The JPEG picture 1024x1024 pixels is preferred.

### Text

Max. booklet text files no.=32 if not present filename=00 . . . 00

Text Format Code:

1B: e.g. 0x00—ASCII, 0x01—UTF-16, 0x02 HTML etc. (other reserved)

Total language number (1B) —address: 0x1 D56 describes total language number of maximum 8 relating to each album.

### Video

Max. Album Booklet video files: 32 if not present filename=00 . . . 00

Video Format Code:

1B: e.g. 0x00—MP4, 0x01—MP4 (Xvid), 0x02—MPEG2 (DVD) etc. (NTSC/PAL)+popular video code

2B H size (e.g. 720x576 code 720)

2B V size (e.g. 720x576 code 576)

1B Aspect ratio code 5:4 (e.g. 720x576) code 0x00, 3:2 (e.g. 720x420) code 0x01, 16:9 code 0x02, 4:3 (e.g. 1024x768) other reserved

Popular video formats can be coded on first byte together with compression format, i.e.:

DVD: 720x480 (NTSC) or 720x576 (PAL) code: 0x10 PAL or 0x02 NTSC+coding scheme (Xvid code 0x02)−total code 0x12

HDTV: 1,920x1,080 (1080p) code 0x30+ . . . .

1,366x768 (768p) code 0x40+ . . . .

1,280x720 (720p) code 0x50+ . . . .

1,024x768 (HDTV plasma) code 0x60+ . . . .

852x480 (EDTV plasma) code 0x70+ . . . .

640x480 VGA code 0x80+ . . . .

Each video file can provided in three different quality (resolution) variants—this is described by Video files binary codes (0x3898 and 0x38BA8 etc. of GFT in FIG. 6) one byte for each file i.e.: The Byte=HRP:MRP:LRP:(binary coded codec description 5 bits)=HRP high resolution file present (MSb—7th bit)+MRP Mid resolution file present (6th bit)+Low resolution file present (5th bit)

Low resolution video data files (like QVGA: 240x320 pixels) will be suited for simple, portable devices (as mobile phones) with limited computing power.

Each High Definition and Medium resolution video data file should be also stored as additional, low resolution video file. This ensures playability albums even on simplest devices.

Each of the three quality (resolution) variants can be separately defined for each file group in the same way as described above to [079]) slightly after the video binary codes.

### Audio DATA

The “SDMUSA” expression, coded in ASCII must be presented at the beginning of each of SDMusA audio files. In the other words, any *.sda file of any SDMusA album must include address 0x00000 and the following Hexagonal codes: 53 44 4D 55 53 41. It is also described by FIG. 8.

The “SDMUSA” expression, described in point [085] must be detected by every replaying device or computer program using SDMusA format. If “SDMUSA” expression is not detected, replaying device or computer program using SDMusA format must not be able to play audio file.

Use of “SDMUSA” expression by another solution that is not in accordance with SDMusA format is prohibited.

Audio Format Code Definition (Common for all Data Formats):

1B—bit resolution: 0x01 16 bit, 0x02 24 bit, 0x3 32 bit other reserved

1B—sampling frequency: 0x01 44.1 kHz, 0x02 48 kHz, 0x03 88,2 kHz; 0x04 96 kHz, 0x05 176,4 kHz; 0x06 192 kHz other reserved

1B—number of channels: e.g. 0x02-2ch etc.

In an example, binary coded PCM AUDIO quality parameters (address: 0x0018-19) are defined as:

0x00 01 CD (16 bits/44.1 kHz/2ch)

0x00 02 PCM (16 bits/48 kHz/2ch)

0x00 03 PROFESSIONAL AUDIO PCM 24 bits/96 kHz/2ch

0x00 04 PROFESSIONAL AUDIO PCM2 24 bits/192 kHz/2ch

Other to be defined or reserved

The first byte defines the compression format 0x00 for uncompressed audio data

### Uncompressed Audio Data Format

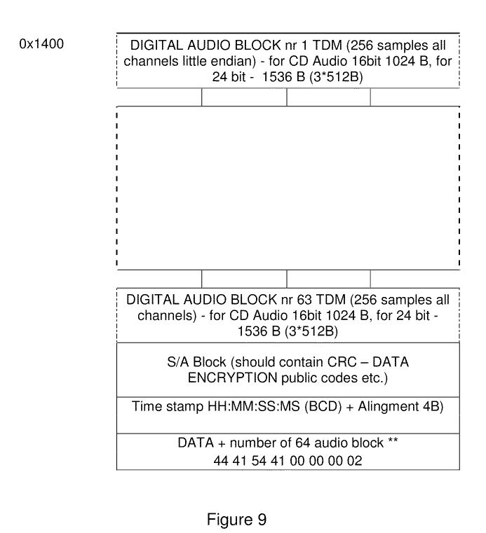

In an embodiment, audio data is a primary block of a predetermined number of samples for example 256 samples (1024 B for CD quality 16 bit/44, 1 kHz non-compressed PCM). Each of the 256 Blocks” plus one Synchro/Alignment Block (S/A Block) comprises one Meta Audio Block. FIG. 9 illustrates a Mega Audio Block (MAB) definition.

“S/A Block” should contain:

Time Stamp: BCD (6B) HH:MM:SS:MS

(hours:minutes:seconds:milliseconds)

CRC or other correction codes

Public keys etc. if the audio content is encrypted

### Compressed Audio Data Format

Compressed audio data: address:0x0023—code 0xFF FF FF FF FF

Binary coded Audio parameters 2B (address: 0x0018-19) —the first byte defines compression format (reserved)

### Uncompressed RAW Audio Data Format

Audio data is Little Endian packed, TDM multiplexed address:0x0023—code 0x00 00 00 00 00

### SDMUSA (Secure Digital Music Album) Format

### Example of Application for Music

The structure of SDMusA format is universal. It can carry all multimedia contents (music, text, video, pictures) for any application.

For music applications, the SDMusA can carry and organize all contents associated with music, including the electronic booklet:

audio tracks (songs, tunes);

text tracks (song lyrics, record information, etc.) related to each track;

album text (artist biography, artist discography, composer review, musician lists, recording equipment list etc.) common to the whole album;
album covers (front, back artwork, booklet pictures, artists photos, historic background photos etc.) common to the whole album;

track covers (artwork) related to each track;

video (concerts, recording sessions, reviews, video clips, etc.) common to the whole album;

video (live, recording session, video clips, etc.) related to each track.

Also, the SDMusA format stores multiple music albums on a single Removable memory device or a single root catalogue.

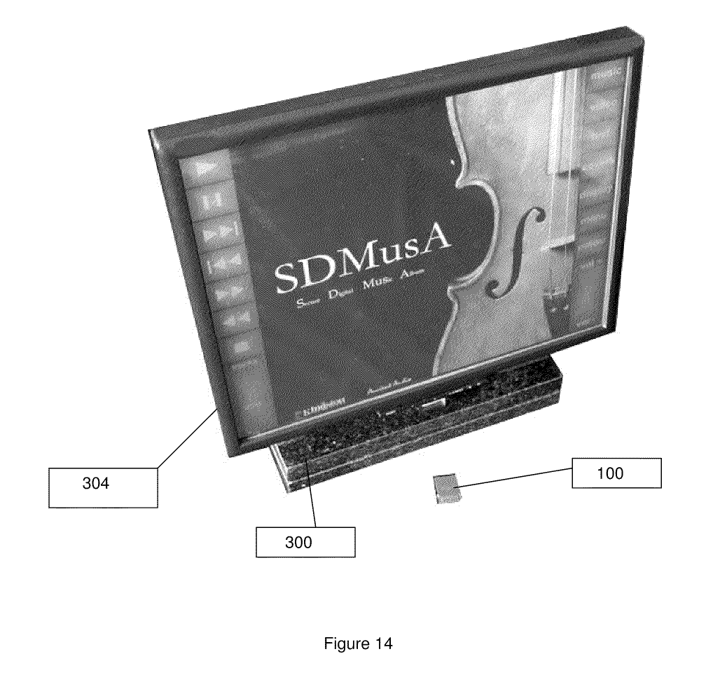

FIG. 14 illustrates an example of an SDMusA player 300, that is able to replay all stored contents on SDMusA card 100. The player has an LCD screen 304, with touch operation. The player can also be operated by traditional keyboard, remote handset or other control devices. The touch LCD screen 304 displays a keyboard, also operated by touch operation. The keyboard layout can be changed according to individual needs. SDMusA data can be replayed on the wide range of devices (portable, personal, car, home, computer, studio etc). SDMusA players are able to play all contents (audio, text, video, picture) or limited (only audio, only audio and pictures etc.).

FIG. 15 illustrates a portion of SDMusA player 300 with an illuminated SD Memory Card socket 308, as well as a mouth-shape input 310 for easy insertion and removal of the card.

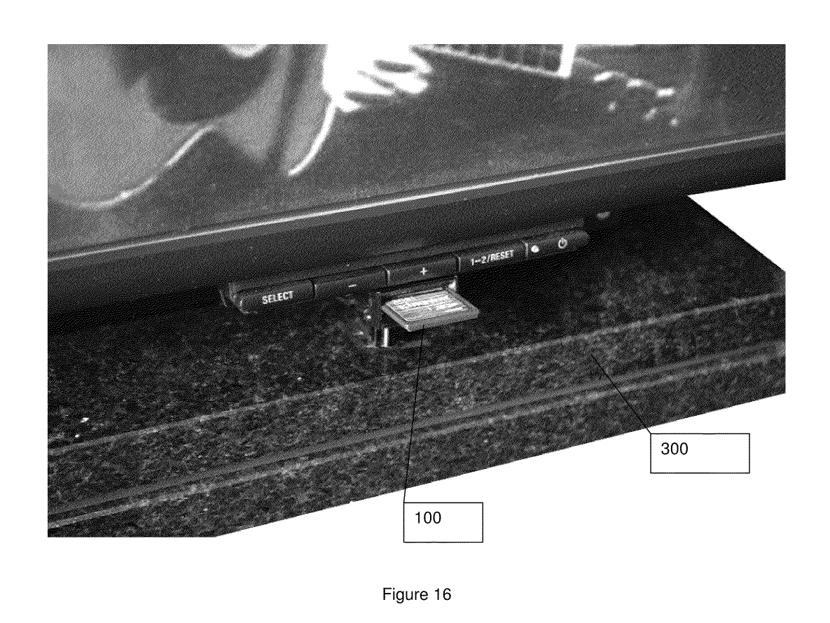

FIG. 16 illustrates an SDMusA player 300 and SD card with SDMusA album(s) 100, which can be easily removed and changed to another card.

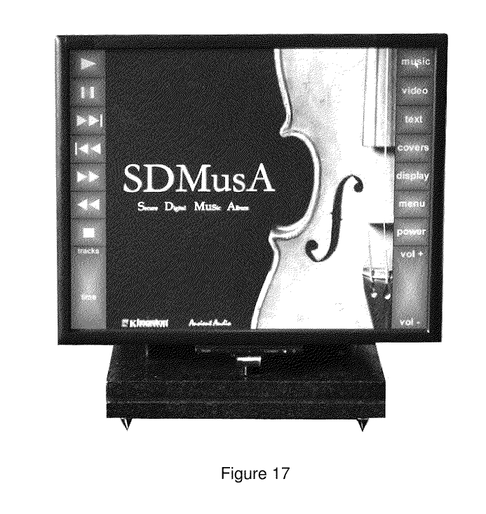

FIG. 17 illustrates an example of an SDMusA main screen layout design.

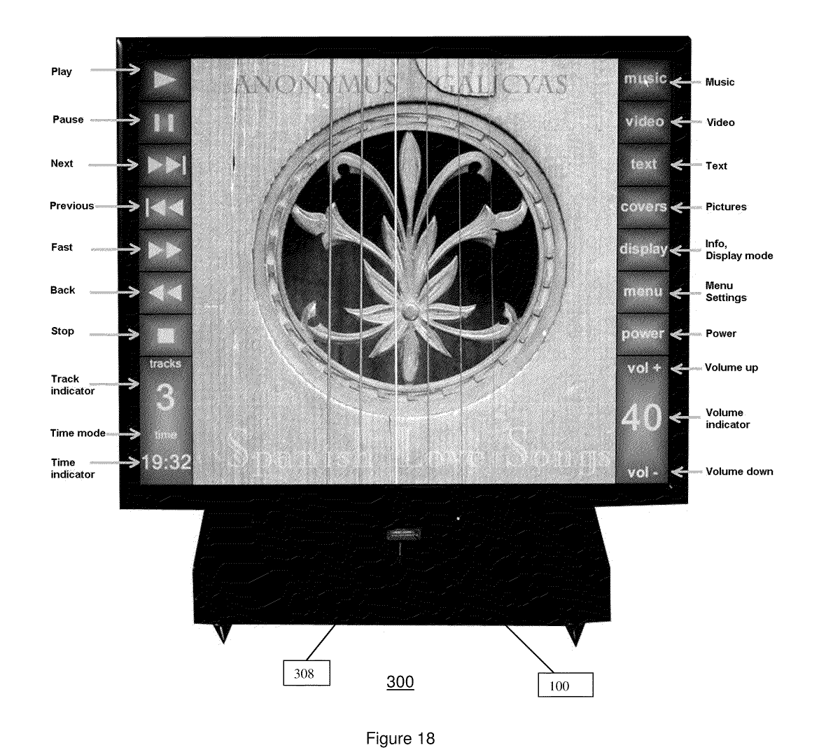

FIG. 18 illustrates that, after placing the SDMusA album 100 inside the card socket 308, the player 300 then reads the album content organization, displays a unique album main cover, as well as total audio tracks quantity, total audio track time, and current volume settings. FIG. 18 also presents a keyboard function of the touchscreen: the left-sided keys operate music or video playing (play, pause, stop, next track, etc.) and the right-sided keys operate additional functions, menus, etc.

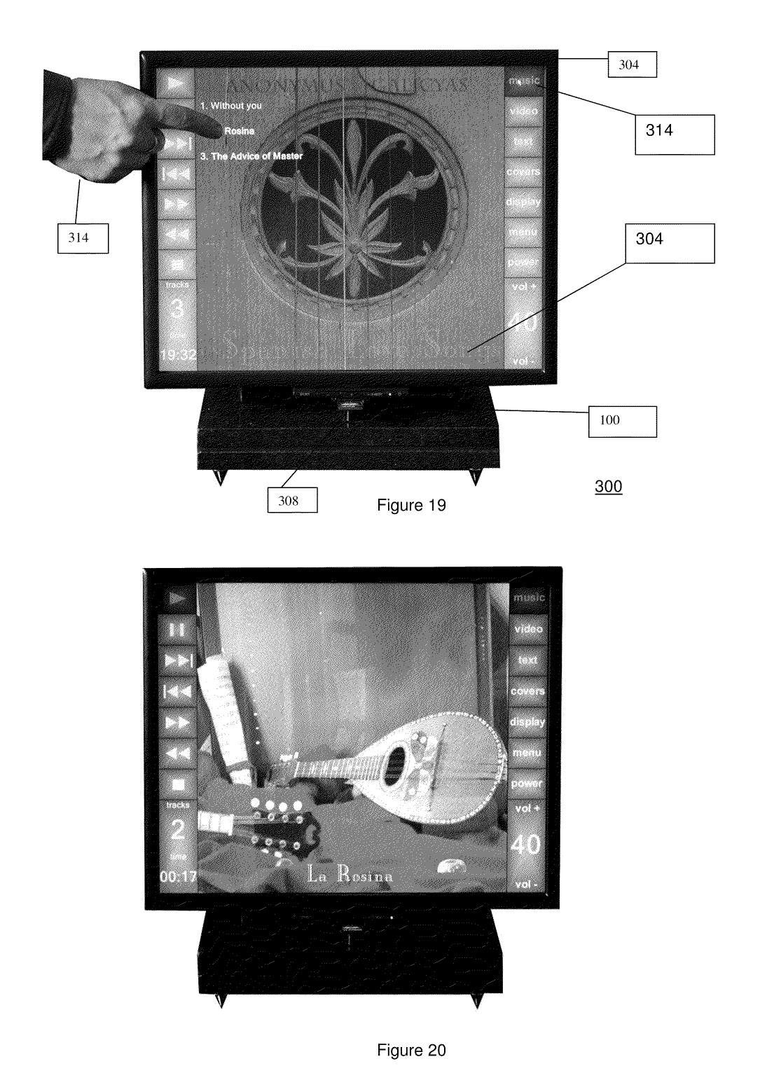

FIG. 19 illustrates that by pressing any content key 314 (right-side) displayed on touchscreen 304, the content lists is displayed. For example, pressing the “music” key will display a list of audio tracks (tunes, songs) titles. The audio track can be selected by left-side keys, or directly by title list. Of course, player can be operated by traditional keyboard or remote handset.

FIG. 20 illustrates that the start playing of each track is indicated by dimmed play key, track number (left-down corner) and unique track artwork.

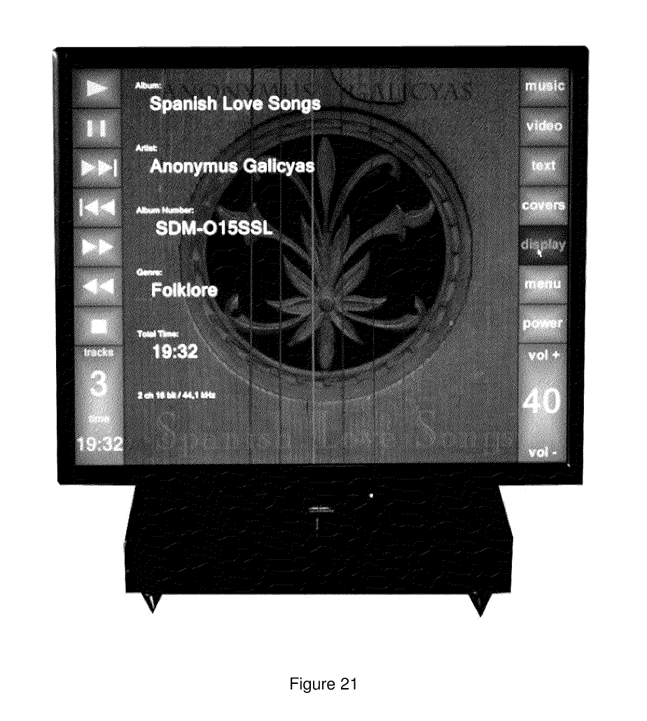

FIG. 21 illustrates that the SDMusA player can display a wide range of text information, such as biography, lyrics, album info, etc.

The SDMusA players can be manufactured as separate, specialized devices whereas SDMusA itself is used as an unique software application for computers, mobile phones, TV sets etc.

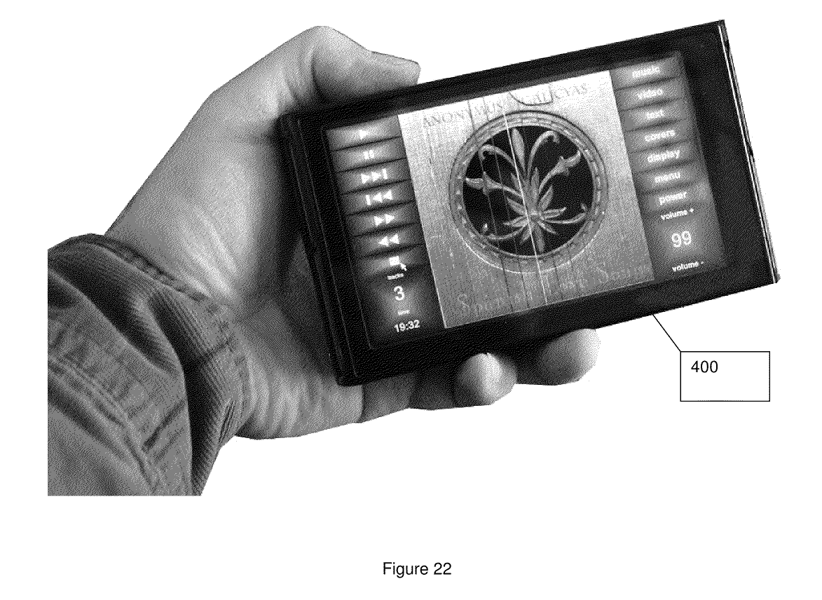

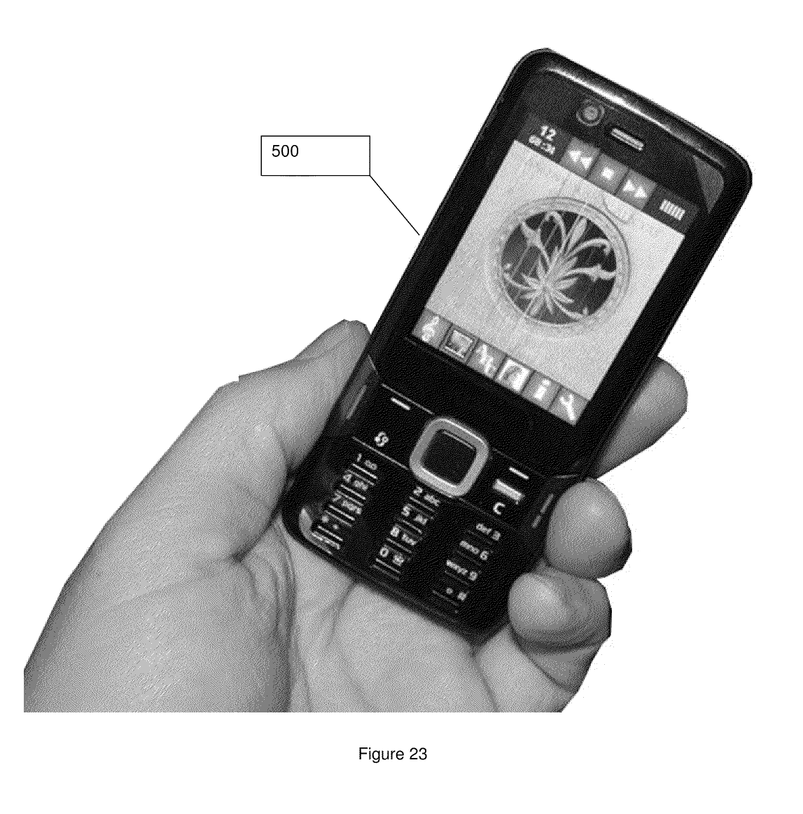

There are different devices and different operate ways (keyboard, touchscreen, remote control, joystick etc). But the operation of all the SDMusA players on different devices should be similar. FIG. 22 illustrates an SDMusA player as software application for portable computer 400 operate by touchscreen. FIG. 23 illustrates an SDMusA player as software application for mobile phone 500 operate by navigation keys.

The SDMusA players can read all contents stored as SDMusA albums (audio, text, picture, video), or only part of them (for example only audio).

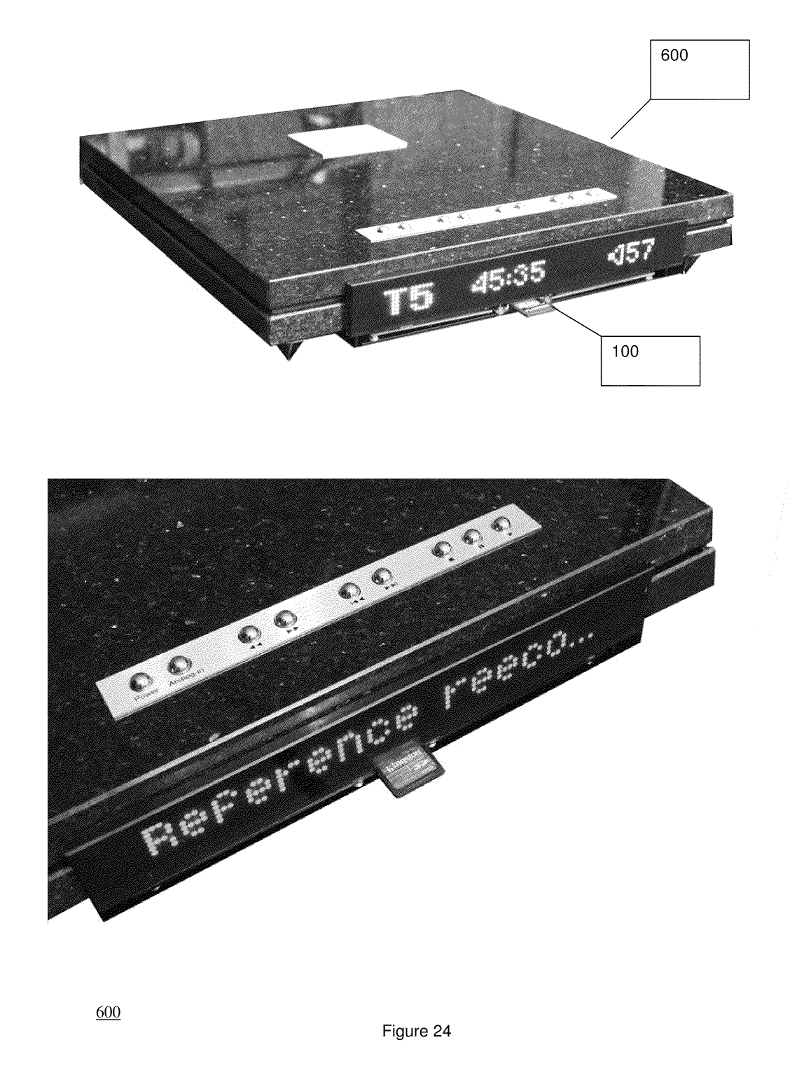

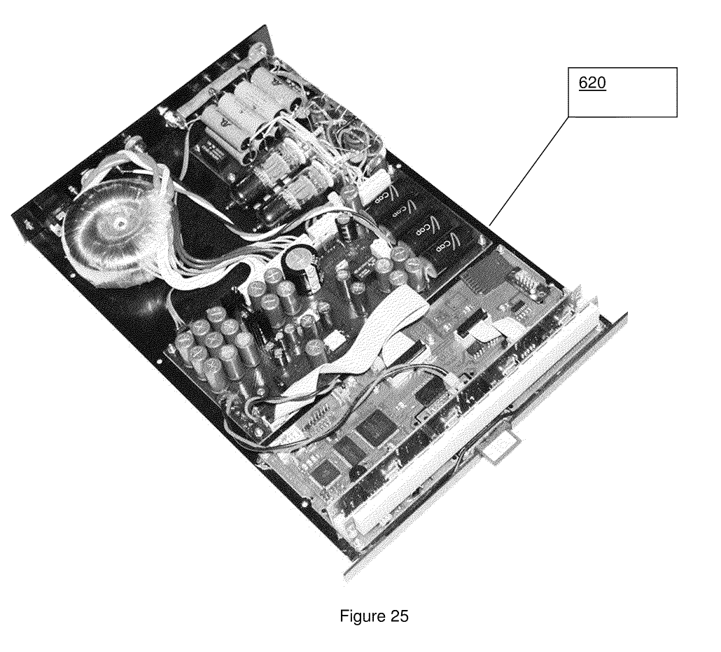

FIG. 24 illustrates a prototype of state-of-the-art SDMusA audio player 600. It can play only audio contents and display main album information. FIG. 25 illustrates an internal build of an SDMusA audio player 620. Due to dedicated internal architecture, short signal path, lack of moving parts sound quality of the SDMusA prototype audio player is better than a high quality CD player.

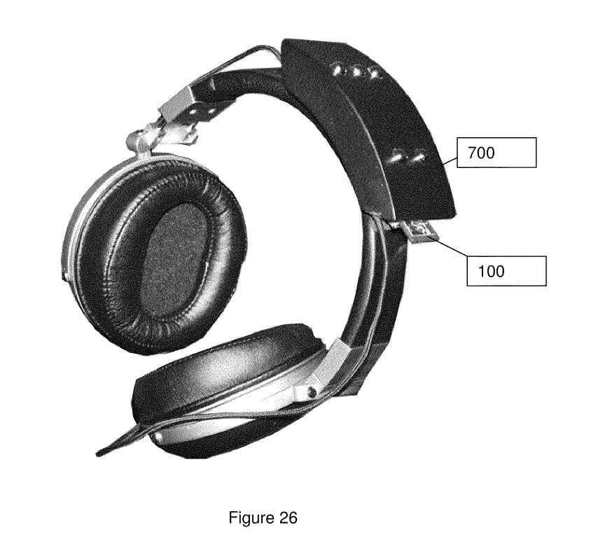

FIG. 26 illustrates a high quality, portable SDMusA player integrated with headphones 700. It can play only audio data. Despite of lack of display operation is very simple due to easy changing of the SDMusA cards 100.

### CONCLUSION

A multimedia application format and method of use is disclosed. Accordingly, instead of exchanging the data associated with multimedia information from one media carrier to another, the media carrier itself is transferred from one player to another. The media is integrated, easy to use, and is possible to apply both to the low quality as well as the high quality audio environment.

A new format for the memory card is provided. The new format includes but is not limited to music, as well as a booklet, cover, text information, video and photo gallery. The new format does not limit the Removable Memory Device to only a media carrier but constitutes, rather, a dedicated and controlled interface to Internet contents. At the same time, there are be a range of players that are created for personal, portable, car audio, as well as hi-fi and hi-end.

The secure digital music album (SDMusA) format provides many advantages over conventional formats. The format allows for additional contents, that are global (related to the whole album); and high resolution pictures as, for example, used in the front cover, back cover, and internal artwork. Local (individual) high resolution pictures for each track (song, tune, chapter) can also be included. An electronic booklet including any text information related to the global (album) or local (track, songs, tunes, chapters) card album ingredients, can be included. A video clip (one or more), as well as a high quality movie (PAL, NTSC, SVGA, HDTV or even higher resolution), can also be included. Video clips can be related to global contents (album) or local contents (song, track, tune, and chapter).

This format can be utilized with a high quality uncompressed audio data as well as compressed data. This format can also be utilized irrespective of the media used. Accordingly, a robust format is provided that can be utilized on a variety of digital players in a variety of environments.

The method and system have been described in accordance with the exemplary embodiments shown, and one of ordinary skill in the art will readily recognize that there could be variations to the embodiments, and any variations would be within the spirit and scope of the method and system. It should be understood for example that although data for different features is stored at particular addresses as described above it should be understood that a system and method in accordance with the present invention is not so limited. Similarly although there are a predetermined sizes for elements such as the number of albums, the number of audio tracks, the number of pictures etc one of ordinary skill in the art that recognize that the predetermined size or number could be of any value and still be within the spirit and scope of the present invention. Accordingly, many modifications may be made by one of ordinary skill in the art without departing from the spirit and scope of the appended claims.

What is claimed is:

1. A system for providing multimedia information comprising:
a device, the device having a slot to allow connection to a memory device therein, the device being capable of executing data a Removable Memory Device inserted in the slot of the device; the Removable Memory Device including multimedia data, the Removable Memory Device having a format that includes a predetermined information set that is described and physically stored thereon.

2. The system of claim 1 wherein the device comprises any of a home Hi-Fi, Hi-end systems, portable player, personal audio, the car and computer.

3. The system of claim 1 wherein the Removable Memory Device comprises any of an SD card, CF card, and a USB Flash memory device.

4. The system of claim 1 wherein the predetermined information set comprises a plurality of albums, wherein a predetermined number of albums are supported on the card.

5. The system of claim 1 wherein the album includes an audio tracks, album pictures, album text and album videos wherein a predetermined number of each of the audio tracks, album pictures, album text and album videos are supported on the card.

6. The system of claim 1 wherein the format includes at least one table of contents TOC file and there is a unique expression within the at least one TOC file that must be detected before any content within the album can be played or reproduced.

7. A Removable Memory Device comprising:
a media for storing multimedia data of a format that includes a predetermined information set that is described and physically stored on the media.

8. The Device of claim 7 wherein the predetermined information set comprises a plurality of albums, wherein a predetermined number of albums are supported on the device.

9. The Device of claim 7 wherein the album includes an audio tracks, album pictures, album text and album videos wherein a predetermined number of each of the audio tracks, album pictures, album text and album videos are supported on the device.

10. The Device of claim 7 wherein the format includes at least one table of contents TOC file and there is a unique expression within the at least one TOC file that must be detected before any content within the album can be played or reproduced.

11. A secure digital music album format comprising:
a plurality of table of content (TOC) files, wherein each TOC file includes a plurality of standardized names; and
at least one unique expression coded into each of the TOC files, wherein if the unique expression is not detected by a device, the device will not be able to replay or reproduce the contents of the album.

12. The format of claim 11 wherein the format supports multiple albums and includes menus for audio, text, video and pictures.

13. The format of claim 11 wherein the format supports compressed and uncompressed data.
